(19) United States
(12) Patent Application Publication
(10) Pub. No.: US 2011/0154309 A1
(43) Pub. Date: Jun. 23, 2011

(54) COMPILER WITH ENERGY CONSUMPTION PROFILING

(75) Inventors: Ali Sazegari, Cupertino, CA (US); Charles Randolph Overbeck, Sunnyvale, CA (US)

(73) Assignee: APPLE INC., Cupertino, CA (US)

(21) Appl. No.: 12/645,368

(22) Filed: Dec. 22, 2009

(51) Int. Cl. G06F 9/45; G06F 9/46

(52) U.S. Cl. 717/153; 719/331

(57) ABSTRACT

An energy based framework is disclosed that allows a software compiler or developer to make decisions between performance and energy consumption. In one aspect, a first program code (e.g., vector engine based computation) may alternatively be compiled into a second program code (e.g., register operations). Using measurements obtained from a processor for which the first and second program codes are being compiled, and the expected size of the data and a number of iterations, a comparison can be made between the expected energy consumption profile of the first program code and the equivalent second program code. Based on the comparison, a software developer or the compiler can choose the program code that minimizes energy consumption.

### TECHNICAL FIELD

This subject matter is related generally to software compilers.

### BACKGROUND

Modern mobile devices are capable of performing a variety of applications. These applications can quickly consume the limited battery power of the mobile device. To increase batter life, it is desirable to develop applications for the mobile device that are power efficient. Test beds can be developed to determine the energy cost of a specific instruction for a specific processor. The typical software developer, however, relies on basic production computers to develop software. Test beds can be used to generate energy cost tables that estimate the energy cost of a particular program code. These tables, however, are specific to a processor and instruction set and may not account for all power consumption events that can occur while the code is being executed by the processor.

### SUMMARY

An energy based framework is disclosed that allows a software compiler or developer to make decisions between performance and energy consumption. In one aspect, a first program code (e.g., vector engine based computation) may alternatively be compiled into a second program code (e.g., register operations). Using measurements obtained from a processor for which the first and second program codes are being compiled, and the expected size of the data and a number of iterations, a comparison can be made between the expected energy consumption profile of the first program code and the equivalent second program code. Based on the comparison, a software developer or the compiler can select the program code that minimizes energy consumption.

### BRIEF DESCRIPTION OF THE DRAWINGS

FIG. 1 is a block diagram of an exemplary computer system for compiling software programs, including computing an energy consumption profile for program code.

FIG. 2 is a block diagram of an exemplary compiler system for computing an energy consumption profile for program code.

FIG. 3 is a flow diagram of an exemplary process for computing an energy consumption profile for program code.

### DETAILED DESCRIPTION

### Example Computer System

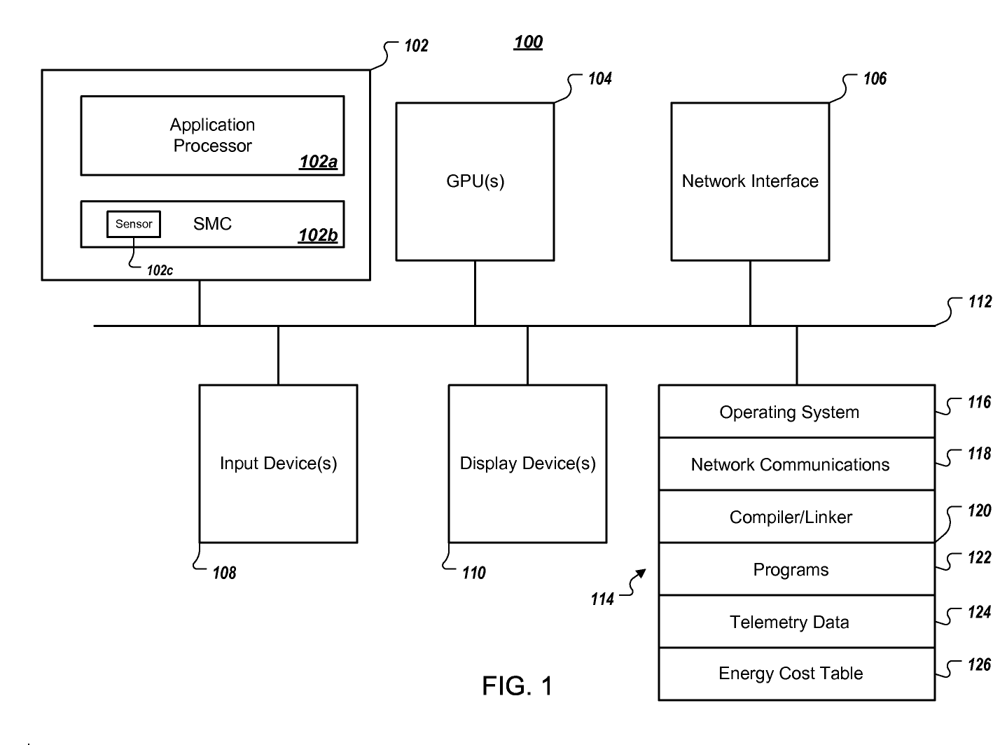

FIG. 1 is a block diagram of an exemplary system 100 for compiling software programs, including computing an energy consumption profile for program code. System 100 can be any electronic device that runs software applications derived from compiled instructions, including without limitation personal computers, servers, smart phones, media players, electronic tablets, game consoles and email devices. In some implementations, system 100 can include one or more application processors or processing cores 102, one or more graphics processing units (GPUs) 104, one or more network interfaces 106, one or more input devices 108, one or more display devices 110 and one or more computer-readable mediums 114. Each of these components can be coupled together by one or more buses 112.

Processor 102 can be any known microprocessor technology, including but not limited to Intel® Multi-Core Technology. In some implementations, processor 102 includes an application processor 102a and a System Management Controller (SMC) 102b. SMC 102b can include one or more sensors 102c that monitor one or more of temperatures, voltages, currents, fans, power supplies, bus errors, system physical security and any other metrics or data that could be used to detect or predict system malfunction. For example, application processor 102a could become overheated while running an application. Sensor 102c can be a temperature sensor in SMC 102b that detects the temperature rise in the system 100 due to application processor 102a. In response to the detection, SMC 102b can send a command to increase fan speed or reduce the speed of application processor 102a. The data detected or monitored by sensor 102c is also referred to herein as “telemetry data.” In some implementations, sensor 102c can be located anywhere in system 100 (e.g., outside of SMC 102c).

Display device 110 can be any known display technology, including but not limited to display devices using Liquid Crystal Display (LCD) or Light Emitting Diode (LED) technology. GPU 104 can be any known graphics processor technology, including but are not limited to NVIDIA™ GeForce™ processor technology. Input device 108 can be any known input device technology, including but not limited to a keyboard (including a virtual keyboard), mouse, track ball, and touch-sensitive pad or display. Bus 112 can be any known internal or external bus technology, including but not limited to ISA, EISA, PCI, PCI Express, NuBus, USB, Serial ATA or FireWire. Computer-readable medium 114 can be any medium that participates in providing instructions to processors 102 for execution, including without limitation, non-volatile media (e.g., optical disks, magnetic disks, flash drives) or volatile media (e.g., SDRAM, ROM etc.).

Computer-readable medium 114 can include various instructions 116 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 108; sending output to display device 110; keeping track of files and directories on computer-readable medium 114; controlling peripheral devices (e.g., disk drive, printer) which can controlled directly or through an I/O controller (not shown); and managing traffic on bus 112. Network communications instructions 118 can establish and maintain network connections (e.g., software for implementing communication protocols, such as TCP/IP, HTTP, Ethernet).

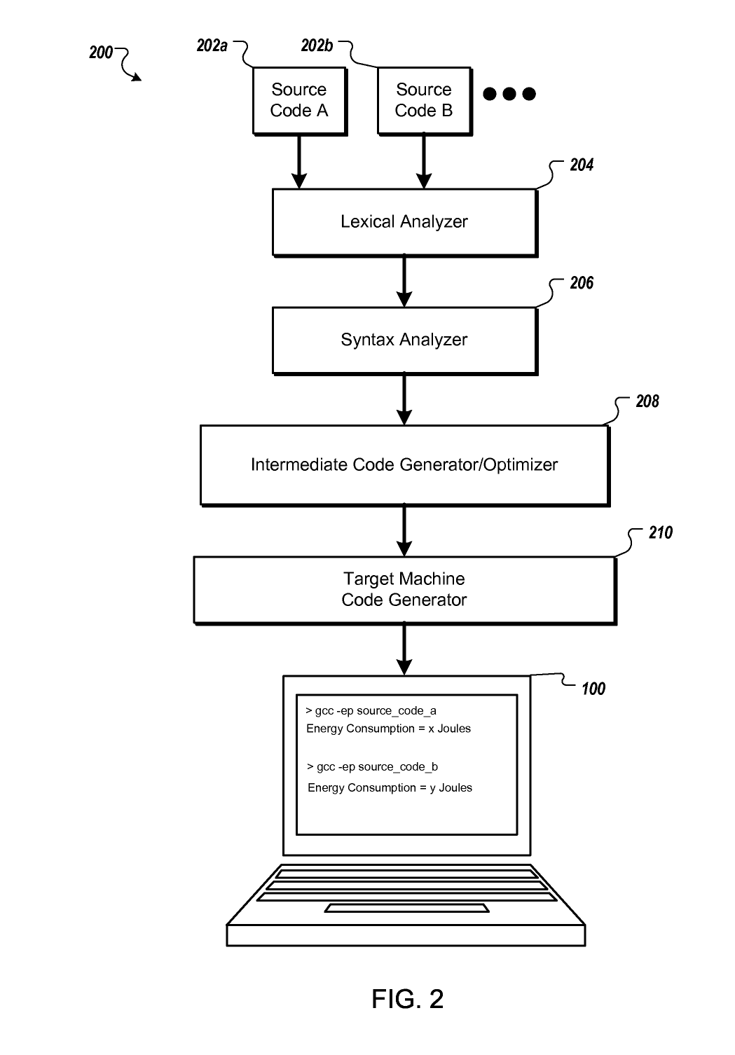

Compiler/Linker instructions 120 can implement compiler and linker operations as described in reference to FIG. 2 Programs 122 can be one or more of source code files as described in reference to FIG. 2. Telemetry data 124 can be provided by sensor 102c and can include data that can be used by SMC 102b to manage the health of system 100. Energy cost table 126 can include data related to energy consumption of various computations, operations or instructions which can be used to compute energy consumption profiles when telemetry data is not available.

### Example Compiler System

FIG. 2 is a block diagram of an exemplary compiler system 200 for computing an energy consumption profile for program code. Compiler system 200 will be described in reference to system 100 which implements compiler system 200.

A compiler is a computer program (or set of programs) that transforms source code written in a computer language (the source language) into another computer language (the target language, often having a binary form known as object code). A compiler is likely to perform many or all of the following operations: lexical analysis, preprocessing, parsing, semantic analysis, code generation, and code optimization. An example compiler is the publicly available GNU Compiler Collection (GCC) produced by the GNU Project supporting various programming languages. GCC has been adopted as the standard compiler by most modern Unix-based computer operating systems, including GNU/Linux, the BSD family and Mac OS™ X. GCC has been ported to a wide variety of processor architectures (e.g., ARM processors), embedded platforms, and targets a wide variety of platforms.

In some implementations, the compiler system 200 can include lexical analyzer 202, syntax/semantic analyzer 204, intermediate code generator/optimizer 206, target machine code generator 208 and target system 100. Compiler system 200 can be implemented on system 100 or on a separate computer. Compiler system 200 can be a single pass or multi-pass compiler.

A software developer can prepare various source code instructions to be compiled and run on target system 100. In the example shown, the developer has prepared source code 202a (“source code A”) and source code 202b (“source code B”). The target system 100 is a laptop computer with limited battery power. Source code A includes some vector operations and source code B includes equivalent register operations. The developer would like to develop source code that minimizes energy consumption when run on target system 100.

In a first pass through compiler system 200, source code A is processed by lexical analyzer 202. Lexical analyzer 202 breaks source code A into a linear sequence of “tokens” which are single atomic units of a programming language (e.g., a keyword, identifier, symbol name). The token sequence is processed by syntax/semantic analyzer 204 to identify the syntactic structure of the program. For example, a parse tree structure built according to rules of a formal grammar which define the syntax of the language can replace the linear sequence of tokens produced by lexical analyzer 202. Semantic analysis adds semantic information to the parse tree and builds a symbol table. Intermediate code generator/optimizer 206 uses the results of syntax/semantic analyzer 204 to generate and optimize an intermediate code. The intermediate code is transformed by target machine code generator 208 into the native language of target system 100. The native language can be run by target machine 100 on application processor 102a.

While target machine 100 runs the program generated by source code A on application processor 102a, SMC 102b periodically receives telemetry data from sensor 102c (e.g., every 1 millisecond). SMC 102b can collect and retain the telemetry data (e.g., in cache memory) while the program code executes on application processor 102a. Once the code completes execution, the telemetry data can be read out of SMC 102b by application processor 102a and used to compute an energy profile.

The telemetry data includes voltage, V(t) and current I(t). An instantaneous power consumed at time t is given by P(t)=V(t)I(t). An estimate of the energy Eₐ consumed by application processor 102a running the program derived from source code A over the interval t₁ to t₂ is given by

Eₐ≈∫ₜ_{₁}^{t}^{₂}P(t)dt. [1]

In practice, the integral in [1] can be calculated using one of several well-known integration techniques (e.g., Newton-Cotes integration formulas, trapezoidal rule). The interval can be any desired time frame (e.g., 300 milliseconds). The energy Eₐ can be displayed to the developer at the end of compilation. In some implementations, the energy calculation can be invoked with a compiler command by using a compiler flag. In the example shown, using a GCC compiler, an example UNIX command line can be: {>gcc −ep source_code_a}, where “−ep” invokes the energy consumption profile computation of [1].

The developer can proceed to perform the same process on source code B and compute energy E_{b}. If Eₐ<E_{b}, then the developer knows that source code A (with vector computations) is more efficient for the desired program code than source code B (register operations).

In some implementations, a program code could be run on more than one processor. For example, multiple application processors 102 can be run with one or more GPUs 104. To capture the energy consumption by an additional GPU, a second SMC can be added to the GPU, or the GPU can be configured to report telemetry data to other devices having an SMC or a central SMC. Alternatively or additionally, an energy cost table 126 can be provided which lists the energy cost for each GPU operation (e.g., in Joules). The energy costs for operations performed by GPU 104 or other processors (e.g., multiple cores, coprocessors) can be retrieved from energy cost table 126 and added to the energy consumption data computed based on telemetry data from SMC 102b to generate a total energy consumption profile for the program code.

### Example Compiler Process

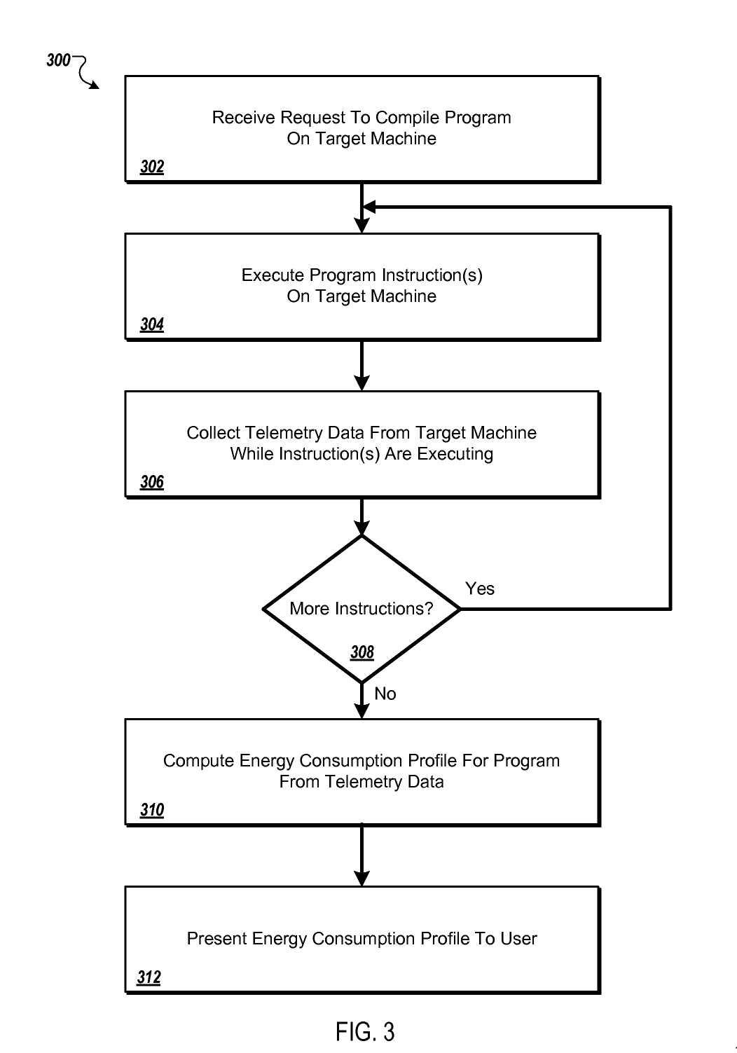

FIG. 3 is a flow diagram of an exemplary compiler process 300 for computing an energy consumption profile for program code. Process 300 will be described in reference to system 100 which implements process 300.

In some implementations, process 300 can begin when a request is received to compile program code on a target machine (302). The request can be a compiler command with a compiler flag indicating that an energy consumption profile is desired. One or more instructions of the program code are executed on system 100 (304). Telemetry data is collected by SMC 102b from sensor 102c or any other sensor in system 100. Telemetry data can include instantaneous voltage and current. If process 300 determines that more instructions are available for execution (308), those additional instructions are executed until all instructions are executed.

If process 300 determines that all instructions have be executed (308), an energy consumption profile is computed from telemetry data (310). The telemetry data (which can include voltage and current) can be used to compute an instantaneous power. The instantaneous power can be integrated over a time interval to provide the energy consumed by the system 100 during the time interval, as described in reference to FIG. 2.

An energy consumption profile can be presented to the user (312). The profile can be displayed on display device 110 as a single number or can be compared and plotted with other energy consumption data as desired. A developer can use the energy consumption profiles to determine which program code will be included in a production application.

In some implementations, libraries having different energy consumption profiles can be dynamically linked into an application during runtime based on a power state (e.g., the battery life) of the system 100 running the application. Dynamic linking involves loading the subroutines of a library into an application program at runtime, rather than linking them in at compile time; the subroutines can remain as separate files on disk. The linker records what library routines the program code needs and the index names or numbers of the routines in the library. The remaining work of linking can be done at the time the application is loaded or during runtime. The linking code (e.g., a loader) can be part of the underlying operating system (e.g., operating system 116). At the appropriate time the loader finds the relevant energy efficient library on disk and adds the relevant data from the library to the memory space of the processor. For example, the application can query the operating system (or a power management system) for the existing battery life of the system, and based on the battery life, select the library having the more efficient energy consumption profile, then dynamically link the library to the application.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, e.g., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or cores executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request to compile a first set of program instructions to run on a processor;
executing the first set of program instructions on the processor, the executing including:
obtaining a first set of telemetry data from a sensor; and
computing a first energy consumption profile from the first set of telemetry data over a time interval during which the first program instructions are executing on the processor.

2. The method of claim 1, where the first set of telemetry data is obtained by a sensor in a controller monitoring the processor while the processor executes the first set of program instructions.

3. The method of claim 3, where computing the first energy consumption profile comprises:
computing an instantaneous power from the first set of telemetry data; and
integrating the instantaneous power over a time interval.

4. The method of claim 3, where computing the first energy consumption profile comprises:
accessing at least some energy consumption data related to the program instructions from an energy cost table.

5. The method of claim 1, comprising:
receiving a request to compile a second set of program instructions to run on the processor;
executing the second set of program instructions on the processor, the executing including:
collecting a second set of telemetry data from the sensor; and
computing a second energy consumption profile from the second set of telemetry data over the time interval.

6. The method of claim 5, further comprising
comparing the first and second energy consumption profiles to determine which one of the first or second sets of program instructions consumes the least amount of energy while executing on the processor.

7. A computer-implemented method comprising:
launching an application on a system;
determining a current power state of the system; and
dynamically linking either a first library or a second library with the application based on the current power state and energy consumption profiles associated with the first and second libraries, respectively.

8. The method of claim 7, where the energy consumption profiles are determine from telemetry data provided by a sensor of the system running the application.

9. A software compiler method comprising:
receiving a compiler command with a compiler flag and a filename associated with program code;
determining that the compiler flag is requesting an energy consumption profile for the program code;
compiling the program code, the compiling including:
using a first processor to collect telemetry data from a sensor while a second processor is compiling the program code; and
computing an energy consumption profile from the telemetry data.

10. The method of claim 9, where computing the energy consumption profile comprises:
computing an instantaneous power from the telemetry data; and
integrating the instantaneous power over a time interval during the compiling.

11. The method of claim 9, where computing the energy consumption profile comprises:
accessing at least some energy consumption data related to the program instructions from an energy cost table.

12. A computer-readable medium having instructions stored thereon, which, when executed by a processor, causes the processor to perform operations comprising:
receiving a request to compile a first set of program instructions to run on a processor;
executing the first set of program instructions on the processor, the executing including:
obtaining a first set of telemetry data from a sensor; and
computing a first energy consumption profile from the first set of telemetry data over a time interval during which the first program instructions are executing on the processor.

13. The computer-readable medium of claim 12, where the first set of telemetry data is obtained by a sensor in a controller monitoring the processor while the processor executes the first set of program instructions.

14. The computer-readable medium of claim 13, where computing the first energy consumption profile comprises:
computing an instantaneous power from the first set of telemetry data; and
integrating the instantaneous power over a time interval.

15. The computer-readable medium of claim 13, where computing the first energy consumption profile comprises:
accessing at least some energy consumption data related to the program instructions from an energy cost table.

16. The computer-readable medium of claim 12, comprising:
receiving a request to compile a second set of program instructions to run on the processor;
executing the second set of program instructions on the processor, the executing including:
collecting a second set of telemetry data from the sensor; and
computing a second energy consumption profile from the second set of telemetry data over the time interval.

17. The computer-readable medium of claim 16, further comprising
comparing the first and second energy consumption profiles to determine which one of the first or second sets of program instructions consumes the least amount of energy while executing on the processor.

18. A compiler system comprising:
a processor;
a computer-readable medium coupled to the processor and including instructions which when executed by the processor causes the processor to perform operations comprising:
receiving a request to compile a program instruction to run on a processor;
executing the program instruction on the processor, the executing including:
obtaining telemetry data from a sensor; and
computing an energy consumption profile from the telemetry data over a time interval during which the program instruction is executing on the processor.
